(19) United States
(12) Patent Application Publication
(10) Pub. No.: US 2019/0299460 A1
(43) Pub. Date: Oct. 3, 2019

(54) Disposable Razor Trimmer Guard

(71) Applicant: Leonardo Lechuga, Chatsworth, GA (US)

(72) Inventor: Leonardo Lechuga, Chatsworth, GA (US)

(21) Appl. No.: 15/944,785

(22) Filed: Apr. 3, 2018

(51) Int. Cl. B26B 21/40

(52) U.S. Cl. CPC B26B 21/4018; B26B 21/14

(57) ABSTRACT

The Disposable Razor Trimmer Guard is a guard that can be molded to fit any disposable razor and formed to have the guards at any length desired for trimming of body hair without the razor blade coming into contact with the skin of the shaver. The guards can be made to be of disposable material or material for long term use.

### BACKGROUND

Disposable Razors have been around for many years. Their primary purpose is to remove unwanted body hair. They have evolved from single blade razors to multi blade razors designed for a cleaner closer shave. What disposable razor manufactures did not account for is modern styles in various cultures. Although original intentions of the disposable razor may have been designed for men to shave unwanted facial hair they did move into the woman's body hair removal arena. Disposable razor were then designed for women to shave their legs. Then can the versatility of using disposable razors to design styles in facial hair. Men could use the razor and cut in a goatee or shave all but a desired style mustache. Women could use to shave pubic hair and design patterns in that area. So, the disposable razor failed to evolve with the times in that styles now call for some hair to remain and not shave completely. The Disposable Razor Trimmer Guard solves that problem in that it allows someone to shave and leave the desired hair but then allows that person to trim that remaining hair to the desired length using the standard-length guards and not having to either shave completely or have the hair grow beyond the desired length and maintain the desired look.

### DESCRIPTION OF VIEWS OF THE DRAWINGS

FIG. 1 shows the Disposable Razor Trimmer Guard from a back view wherein you can see how this model has clips for attaching to its razor head. You can see both the top and bottom edges with the vertical rail guards as well as the side edges.

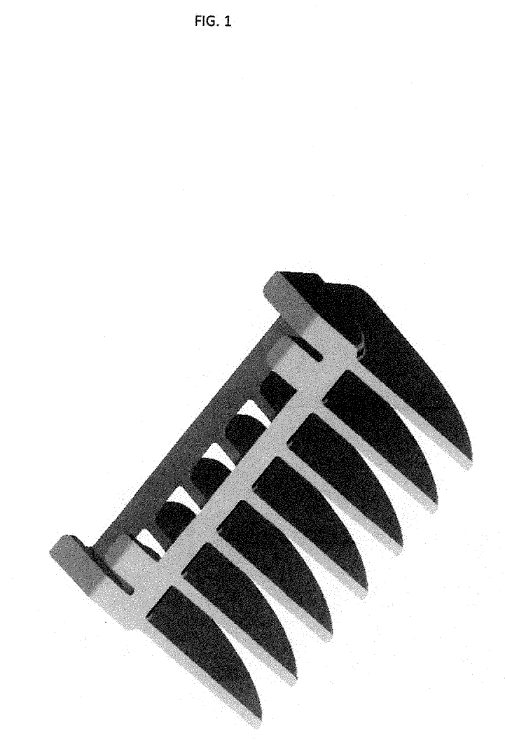

FIG. 2 is a front view of the Disposable Razor Trimmer Guard wherein you can see the vertical rails both top and bottom edges as well as the mounting clips for this head and see the exposed portions of the Disposable Razor Trimmer Guards front so as not to obstruct the razor's blades from trimming the hairs once guided to it by the rails.

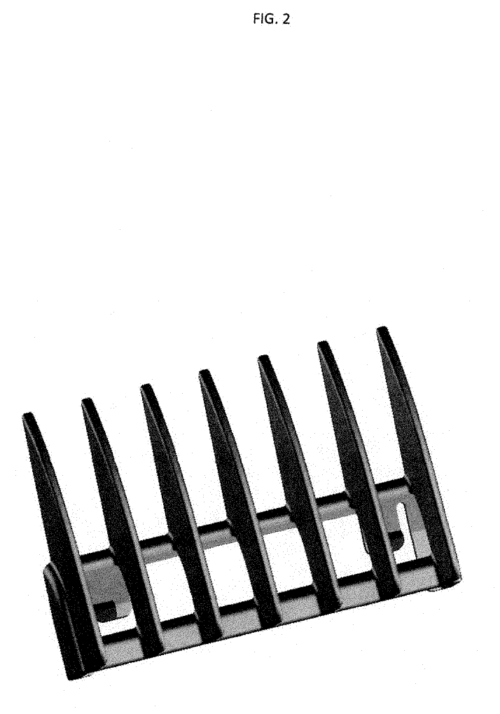

FIG. 3 is an angled view of the back of the Disposable Razor Trimmer Guard wherein you can see the depth of the rails much better as well as see the top and bottom edges as well as side edges from an angle.

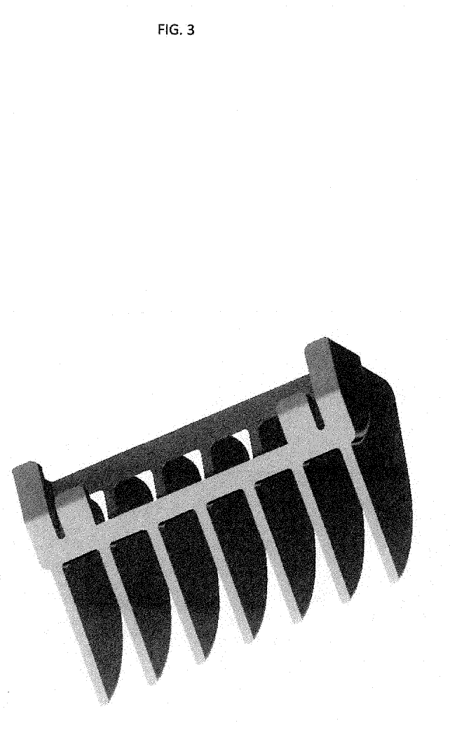

FIG. 4 is an angled view of the front of the Disposable Razor Trimmer Guard wherein you can see the vertical rails and their depth as well as the exposure portion of the guard wherein the razor's blades will have access to the hair for trimming.

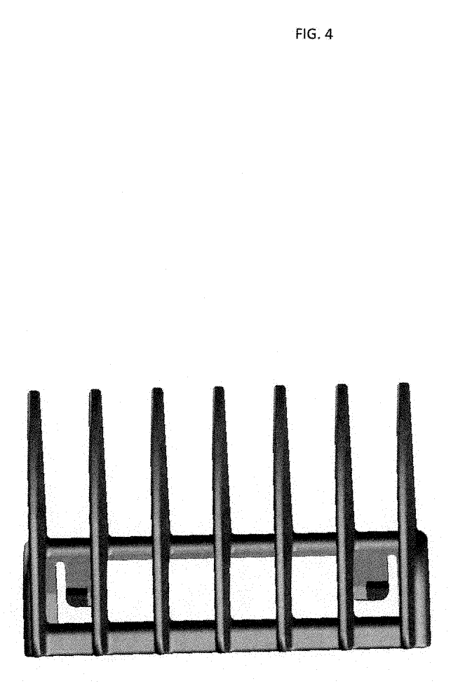

FIG. 5 is an angled view of the Disposable Razor Trimmer Guard in sizes 1 through 4 in two different styles where you can see more clearly the guard rail lengths for the different trimming lengths possible.

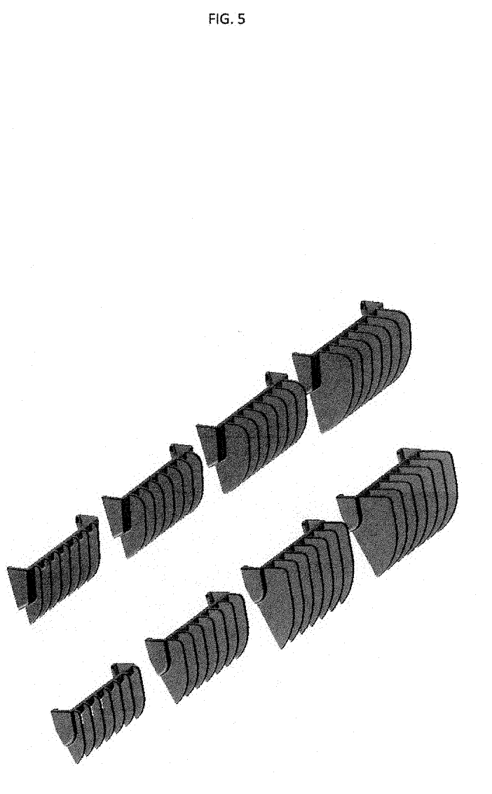

### SPECIFICATION

The Disposable Razor Trimmer Guard is a guard that fits over a disposable razor so that someone can trim body hair with a disposable razor as opposed to an electric trimmer, sometimes referred to as a beard trimmer. The Disposable Razor Trimmer Guard can be made of various materials and molded to any type of disposable razors. It is made to fit over the razor just as a razor cover would or to attach in any manner which would not obstruct the razor or the Disposable Razor Trimmer Guard's functions. The Disposable Razor Trimmer Guard is made to fit over the razor and prevent the razor from cutting all the way to the skin. The razor guards can be made to standard trimmer lengths that have been universally used for electric trimmers. The Disposable Razor Trimmer Guard allows someone to shave, for example, their beard, and leave a mustache and then the mustache can be trimmed to the desired length. As with standard electric trimmers the disposable razor guard can be made in one size or be made in a set of standard sizes for the desired length of cut. It can be used with a disposable razor to trim beard, mustache, legs, head or any other body hair that one desires to trim without shaving down to the skin. Its purpose is to allow those who may not own an electric trimmer to get the same results from their disposable razor. The Disposable Razor Trimmer Guard has vertical rails from top to bottom of the razor guard that can be of any standard length that determine the length of hair that will remain after trimming. The rails are parallel to each other and can number between 5 and 10 rails within the width of the razor blade. Standard blade lengths are as follows:

(1)= 1/16, (2)=⅛, (3)=¼, (4)=⅜, (5)=½, (6)=⅝, (7)=¾, (8)=⅞, and (9)=1 inch.

The Disposable Razor Guard Trimmer is shaped to fit the razor head with guard rails either all the way to the edge or almost to the edge of the razor head. The rails guide the hair between the rails and expose the hair to the blade for trimming. The space between the rails is open to allow the blade or blades of the razor to cut the hair to the length of the rails and no more.

The back side of the Disposable Razor Trimmer Guard leaves the back of the razor exposed so that the trimmed hair can be expelled without obstruction.

There are two side edges that cover the sides if the razor and attach to two front edges that run horizontally to the top and bottom of the razors face. The rails protrude from these front top and bottom edges of the Disposable Razor Guard Trimmer leaving the blade or blades of the razor exposed so that it can still trim the hair to the desired length.

As the Disposable Razor Trimmer Guard fits over the disposable razor head and is secured to the razor in the same manner as would a razor cover and can be configured an any such manner as would allow it to fit over the razor head without obstructing the razor's or the Disposable Razor Trimmer Guard's functions.

The side edges, front top and bottom edges as well as the rails together and form one piece that is the disposable razor trimmer guard

A disposable razor head can be scanned and measured for fit and then those measurements can be used to mold the Disposable Razor Trimmer Guard to fit any disposable razor head so that it will function as intended and therefore be able to trim body hair to the desired length in any of the standard lengths mentioned above or in longer standard lengths beyond those named above.

1: The DISPOSABLE RAZOR TRIMMER GUARD comprising of: a material molded to fit the head of a disposable razor with guard rails running vertically the length of the guard with a top and bottom edge and a right side and left side edge fitting the razor in a manner that allows the blade or blades of the razor to be exposed and molded in a manner in which to attach the DISPOSABLE RAZOR TRIMMER GUARD to the disposable razor head in such a manner as to not obstruct the razors or guard's function, and the rails configured in a manner that will guide the hair to the blade or blades of the razor for trimming to the desired length.

2: The DISPOSABLE RAZOR TRIMMER GUARD of claim 1 further comprising of all of the elements in claim 1 in standard sizes of (1)= 1/16, (2)=⅛, (3)=¼, (4)=⅜, (5)=½, (6)=⅝, (7)=¾, (8)=⅞, and (9)=1 inch and up to any desired size guard rails for trimming body hair to any length.

3: The DISPOSABLE RAZOR TRIMMER GUARD of claim 1 and claim 2 further comprising of being made of a material that can be disposable or a material that can withstand long term use.
